(19) United States
(12) Patent Application Publication
(10) Pub. No.: US 2003/0169781 A1
(43) Pub. Date: Sep. 11, 2003

(54) Device management communication mechanism for selectively addressing multiple devices using single target identifier (TID) - based communication protocol

(75) Inventor: Barry E. Duggan, Hazel Green, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., HUNTSVILLE, AL

(21) Appl. No.: 10/091,016

(22) Filed: Mar. 5, 2002

(51) Int. Cl. H04J 3/04

(52) U.S. Cl. 370/535; 370/539

(57) ABSTRACT

A multiple device management communication mechanism uses the normally empty <GENERAL BLOCK> field of single destination address-based management communication TL1 protocol command structure to selectively insert a substitute recipient address, and thereby selectively transmit a management message from a host site over a communication link to any of plurality of remote subsidiary devices that would otherwise be remotely unaddressable.

### FIELD OF THE INVENTION

The present invention relates in general to communication systems and subsystems therefor, and is particularly directed to a multiple device management communication mechanism that takes advantage of the presence of an intentionally unused field of single target address-based information transport protocol, to embed prescribed transport control information (such as the address of a subsidiary device) within management communications between a supervisory (central office) site and a remote terminal, and thereby enable the transport of management messages to devices at the remote terminal that would otherwise be unaddressable by host equipment at the central office.

### BACKGROUND OF THE INVENTION

Data communication networks often deploy a cluster of intelligent network element (INE) devices which communicate over a common management channel, that is limited to addressing only a single device at a remote end of the link. A reduced complexity diagram of a non-limiting example of this type of network is shown in FIG. 1 as having a central office site 10 and a remote site 20, that communicate with one another over a high bandwidth (optical) communication channel 30. Within the central office site, a host system 11, a communication workstation 12 and a synchronous optical network (SONET) add-drop multiplexer (ADM) 13 are interfaced with each other by way of a local area network (LAN) 14.

The SONET ADM 13 communicates data over the (OC3) optical communication channel 30 with an optical (mux/demux) multiplexer-demultiplexer 21 installed at a remote terminal 20. In order to enable contents of the OC-3 channel to be distributed to their ultimate destination devices, the remote terminal's OC-3 mux/demux 21 is typically coupled over a distributed local network 22, such as a LAN or other link (such as an RS-485 link), to a plurality of subsidiary devices, including but not limited to DS3-T1 mux/demux units 23, and T1-DS0 mux/demux units 24 to which end user (customer premises) equipments 25 are connected.

For device management purposes, the current SONET Interoperability Forum defined management communication protocol standard for communicating over a data communication channel (DCC) is Transaction Language 1 (TL1). Unfortunately, this protocol was designed to support identification and routing of management messages to only a single terminal mode destination address or target identifier (TID))—which, in the network example of FIG. 1, corresponds to the mux/demux 21 that terminates the far end of the OC-3 channel. As such, the host device has no knowledge of and is therefore unable to use this protocol to communicate in terminal mode with other devices in the remote terminal cluster, such as the subsidiary DS3-T1 and T1-DS0 mux/demux units.

One way to address this problem would be to usurp a portion of the available data communication bandwidth for management overhead—something which neither the service provider nor the customer desires. Another approach would involve wholesale replacement of existing equipment or the addition of auxiliary units at each of the host terminal and the remote site—which adds considerable complexity and cost to the network.

### SUMMARY OF THE INVENTION

In accordance with the invention, these addressing limitations of TL1 management communication protocol are effectively obviated, without having to replace or add to existing communication equipment, by upgrading the communication control software in respective units of the network to incorporate a TID-modification mechanism into their communication control software. This selective TID-modification mechanism takes advantage of an intentionally unused portion of the message structure of TL1 protocol, to selectively inject prescribed destination control information (such as the address of a subsidiary device address) within the message structure of management communications between a supervisory (central office) site and a remote terminal.

As will be described, the invention makes use of the normally unused and empty <GENERAL BLOCK> field of the structure of a TL1 protocol message (which is intended to be ignored by a receiving device), to selectively insert a substitute target or destination address as the destination terminal mode device. When a message is received by a device having the upgraded software, the <GENERAL BLOCK> field is examined. If this field is not empty, the <TID> field of the received message is replaced with the contents of the <GENERAL BLOCK> field and the reformatted message is sent to the device having the replacement <TID>.

As a consequence, a management message can be sent to a subsidiary device that would otherwise be remotely unaddressable, using a procedure that is transparent to the host, which assumes it is communicating directly with the subsidiary device. Pursuant to standard TL1 protocol, once the eventual destination device accepts the message, it returns a response message having no <TID> field, and without selective modification, in an upstream direction. The response message is sequentially forwarded back up the link by each intervening device to the originator.

### BRIEF DESCRIPTION OF THE DRAWINGS

FIG. 1 diagrammatically illustrates a reduced complexity data communication network having a cluster of intelligent network element (INE) devices deployed at a remote site;

FIG. 2 is a flow chart showing respective steps of the multiple device management communication mechanism of the present invention; and

FIG. 3 diagrammatically illustrates the data communication network of FIG. 1 modified with target identification labels in association with an example of execution of the multiple device management communication routine of FIG. 2.

### DETAILED DESCRIPTION

Before detailing the single target identifier-based, multiple device management communication mechanism of the present invention, it should be observed that the invention resides primarily in new and improved device management software, that is employed by conventional communication hardware components and attendant supervisory communications microprocessor circuitry that controls the operations of such components of a data communication network. Consequently, the configuration of such components and the manner in which they are interfaced with various data communication channels have been shown in the drawings in readily understandable diagrammatic and flow chart format, to depict only those specific details that are pertinent to the present invention, and avoid obscuring the disclosure with details which will be readily apparent to those skilled in the art having the benefit of the description herein, whereby the invention may be more readily understood.

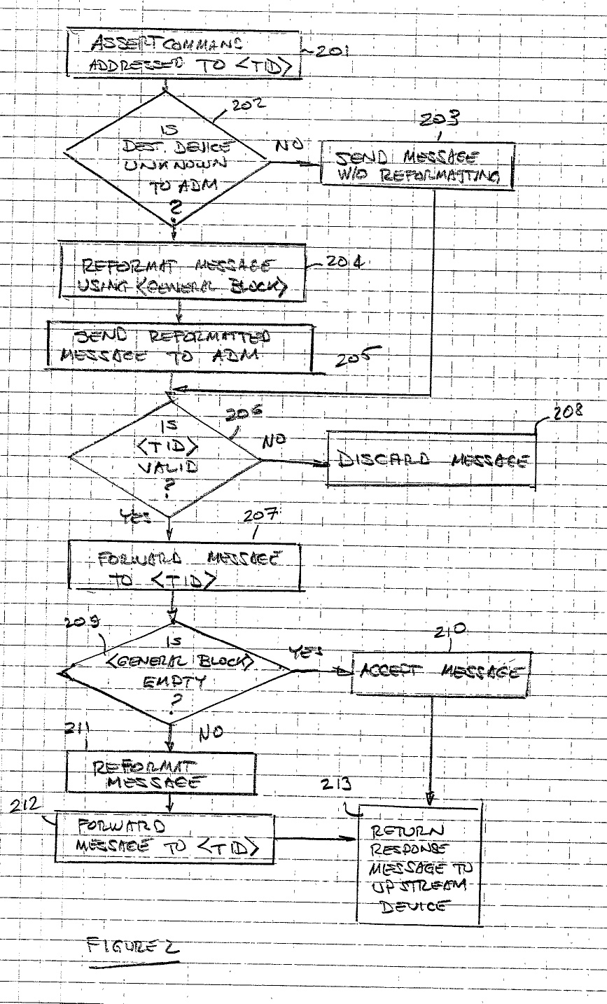

Before describing the respective steps of the multiple device management communication mechanism of the present invention with reference to the flow chart of FIG. 2, it is initially useful to examine the structure of a conventional single address-based (TL1) protocol message, and how that structure provides the ability to embed auxiliary transport control information for forwarding management messages to and from subsidiary or secondary devices (namely to a device other than a single device known to the add-drop multiplexer).

In particular, the structure of a standard TL1 command contains the following fields:

<VERB>: <TID>: <AID>: <CTAG>: <GENERAL BLOCK ‘UNUSED’>: <PARAMETER BLOCK>: <KEYWORD BLOCK>: <STATE BLOCK>;

wherein:

<VERB> is the command to be executed;

<TID> is the target identifier (destination address);

<AID> is the access identifier;

<CTAG> is the correlation tag (alphanumeric identifier that is echoed by the recipient device in its response to the command message);

<GENERAL BLOCK> (a null block that is unused and is always empty);

<PARAMETER BLOCK> contains one or more parameters specific to the command;

<KEYWORD BLOCK> contains one or more terms specific to the command; and

<STATE BLOCK> specific to the command.

As pointed out briefly above, the invention makes use of the normally unused and empty <GENERAL BLOCK> field—that would be otherwise ignored by a recipient device—to selectively insert prescribed auxiliary transport control information (the address of a subsidiary device). In addition, the improved management communication software is modified to examine the contents of the <GENERAL BLOCK> field and, if this field is not empty, to replace the contents of the <TID> field with the contents of the <GENERAL BLOCK> field and forward the reformatted message to the new TID.

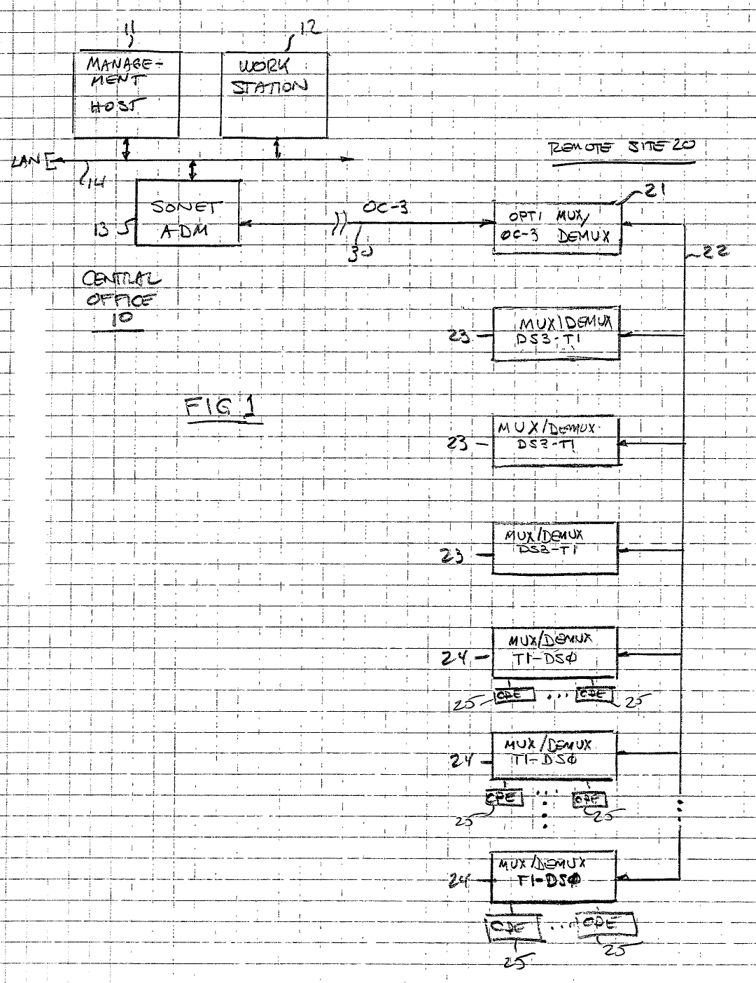

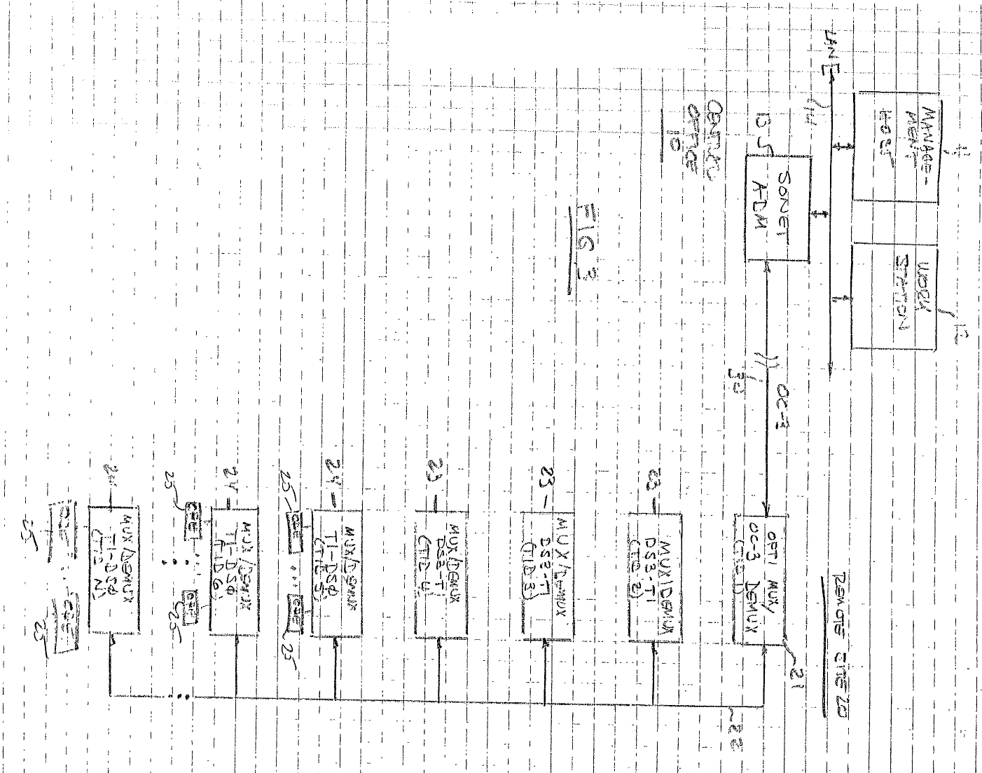

Attention is now directed to the flow chart of FIG. 2, which shows respective steps of a non-limiting example of a management communication data flow sequence between a host system at a central office site with a selected one of a plurality of terminal mode devices at a remote site in the network of FIG. 1. For purposes of illustration, the network of FIG. 1 has been replicated in FIG. 3, which additionally contains individual TID labels (TID1-TIDN) for the components of the remote site cluster 20. In the present example, the case of a communication between the host system 11 with a T1-DS0 mux/demux 24, labelled ‘TID5’, will be discussed.

At step 201, the host system asserts a TL1 protocol-based message, identifying the intended recipient of the message (here—T1-DS0 mux/demux TID5) within the <TID> field onto the local communication channel (LAN 14). Namely, as far as the host is concerned it is communicating directly with the T1-DS0 mux/demux 24, labelled as TID5. In query step 202, this asserted message is examined by the central office's communication workstation 12 to identify the intended recipient of the message, based upon the contents of the <TID> field. For this purpose, as a non-limiting example, the message may be applied to a look-up table, which reformats the message based upon the contents of the <TID> field.

In particular, where the destination device is a device (such as OC-3 mux/demux 21 (TID1)) known to the SONET ADM 13 (the answer to query step 202 is NO), the original message is forwarded in step 203 ‘as is’, with no modification of the empty <GENERAL BLOCK> field. On the other hand, where the <TID> field specifies a destination device (here TID5) unknown to the ADM, the answer to query step 202 is YES, and the routine transitions to step 204. In step 204, the message is reformatted to place the contents of the <TID> field in the <GENERAL BLOCK> field. In addition the <TID> field is used to specify a destination device that is known by the SONET ADM 13 which, in this case, is the OC-3 mux/demux 21 that terminates the OC-3 channel at the remote terminal. At step 205, the reformatted message is sent by the workstation 12 to ADM 13.

In query step 206, the <TID> field of the message is examined by the ADM to determine the intended recipient. As noted above, the ADM always ignores the <GENERAL BLOCK> field. If the contents of the <TID> field are valid, either local (e.g., the ADM itself) or remote (OC-3 mux/demux 21), the answer to query step 206 is YES, and the message is forwarded to that device in step 207. Otherwise the message is discarded in step 208. In accordance with TL1 protocol, whenever a destination device accepts a message as the intended recipient, it returns a response message upstream to the transmitter of the message. The response message has no <TID> field, so that there is no special handling, and the response message is eventually returned to the originator—here the host system.

In the present example of a reformatted message ultimately intended for TID5, the destination device specified in the <TID> field is a valid remote device (TID1), so that in step 207 the ADM 13 forwards the reformatted message over the DCC channel 30 to the OC-3 mux/demux 21 (TID1) at the remote site 20. In query step 209, the recipient device (here, the OC-3 mux/demux 21) examines the <GENERAL BLOCK> field of the received message to determine whether the <GENERAL BLOCK> field is empty.

If the answer to query step 209 is YES, it is inferred that the destination device is specified in the <TID> field and, in step 210, the OC-3 mux/demux 21 accepts the message. However, if the <GENERAL BLOCK> field is not empty (the answer to query step 209 is NO), which is the case in the present example, the message is reformatted in step 211 in a manner complementary to step 204, to place the contents of the <GENERAL BLOCK> field in the <TID> field. Next, in step 212, the message is forwarded from the OC-3 mux/demux 21 (TID1) to the recipient identified in the replaced <TID> field (here TID5). Namely, the intended recipient (TID5) specified by the host is the ultimate recipient of the message as intended, even though the ADM only recognizes the TID specifying the remote unit's OC-3 mux/demux 21. All intervening steps that involve selective address replacement, based upon the contents of the normally ignored <GENERAL BLOCK> field, are transparent to the host and the ADM.

As pointed out above, in accordance with TL1 protocol, when a destination device accepts a message, it returns a response message having no <TID> field, and without selective modification, to the sending device; this response message is returned back up the link to the originator described above. Thus, for the present example, in step 213, in response to receipt of the reformatted message from the OC-3 mux/demux 21, the destination T1-DS0 mux/demux 24 (TID5) returns a response message upstream to TID1 (OC-3 mux/demux 21). Similarly, the OC-3 mux/demux 21 forwards the response message back to the ADM 13. Likewise, the ADM returns the response message back to the workstation 12, which forwards the message back to the host system 11.

As will be appreciated from the foregoing description, the multiple device management communication mechanism of the invention enables single address-based (TL1) management communication protocol to be used to selectively transmit a management message to any of plurality of subsidiary devices that would otherwise be remotely unaddressable. Employing the normally unused and empty <GENERAL BLOCK> field to selectively insert a substitute recipient address makes the invention transparent to the host, which assumes it is communicating directly with the subsidiary device it has addressed.

While I have shown and described an embodiment in accordance with the present invention, it is to be understood that the same is not limited thereto but is susceptible to numerous changes and modifications as known to a person skilled in the art, and I therefore do not wish to be limited to the details shown and described herein, but intend to cover all such changes and modifications as are obvious to one of ordinary skill in the art.

What is claimed:

1. For use with a data communication network having a first transceiver at a host site that communicates over a communication channel with a second transceiver at remote site, said remote having a plurality of network element devices coupled with said second transceiver, a method of enabling a network management device coupled with said host site to conduct management communications with any of said plurality of network element devices at said remote site, said method comprising the steps of:
(a) providing a single destination address-based management communication protocol that supports identification and routing of management messages to only a single destination address, and having a command message structure that includes an intentionally unused information field;
(b) assembling a management message, that is to be coupled to said first transceiver for transmission over said communication channel to said remote site, in accordance with said management communication protocol provided in step (a), and containing a target address identifier field that specifies a selected one of said plurality of network element devices;
(c) modifying the management message assembled in step (a), so as to derive a reformatted management message in which said target address identifier field specifies said second transceiver, and said intentionally unused information field contains information identifying said selected one of said plurality of network element devices at said remote site;
(d) coupling said reformatted management message derived in step (c) to said first transceiver, for transmission over said communication channel to said second transceiver at said remote site; and
(e) receiving said reformatted management message at said second transceiver at said remote site and forwarding said reformatted management message therefrom to said selected one of said plurality of network element devices at said remote site.

2. The method according to claim 1, wherein step (e) comprises examining said reformatted management message for the presence of information in said intentionally unused information field and, in response to detecting information in said intentionally unused information field, changing the contents of said target address identifier field of said reformatted message in accordance with said information in said intentionally unused information field, so as to produce a further reformatted message, and forwarding said further reformatted message to a network element device whose address is contained in the target address identifier field of said further reformatted message.

3. The method according to claim 1, wherein said management communication protocol corresponds to Transaction Language 1 (TL1) protocol, and said intentionally unused information field corresponds to a <GENERAL BLOCK> field of the command structure thereof.

4. The method according to claim 1, wherein said first transceiver comprises an add-drop multiplexer that is operative to transmit messages over said communication channel to only said first transceiver as a valid single destination address, using said single destination address-based management communication protocol.

5. For use with a data communication network having a first transceiver at a host site that is operative to communicate over a communication channel with only a second transceiver at remote site, by using a single destination address-based management communication protocol that supports identification and routing of management messages to only a single destination address, said protocol having a command message structure that includes a target identification field that specifies a single destination address, and an intentionally empty field, a method of enabling a network management device coupled with said host site to conduct management communications with any of a plurality of network element devices at said remote site other than said second transceiver, said method comprising the steps of:
(a) examining the target identifier field of a management message provided from a host device for transmission by said first transceiver over said communication channel, to determine whether said target identifier field identifies the address of one of said plurality of network element devices at said remote site;
(b) in response to the target identifier field examined in step (a) identifying the address of one of said plurality of network element devices at said remote site, reformatting said management message, modifying said management message, so as to derive a reformatted management message in which said target address identifier field specifies said second transceiver, and said intentionally unused information field contains information identifying said selected one of said plurality of network element devices at said remote site;
(c) coupling said reformatted management message derived in step (b) to said first transceiver, for transmission thereby over said communication channel to said second transceiver at said remote site; and
(d) receiving said reformatted management message at said second transceiver at said remote site, and forwarding said reformatted management message therefrom to said selected one of said plurality of network element devices at said remote site, as identified in said unused information field.

6. The method according to claim 5, wherein step (d) comprises examining said reformatted management message for the presence of information in said intentionally unused information field and, in response to detecting information in said intentionally unused information field, changing the contents of said target address identifier field of said reformatted message in accordance with said information in said intentionally unused information field, so as to produce a further reformatted message, and forwarding said further reformatted message to a network element device whose address is contained in the target address identifier field of said further reformatted message.

7. The method according to claim 5, wherein said management communication protocol corresponds to Transaction Language 1 (TL1) protocol, and said intentionally unused information field corresponds to a <GENERAL BLOCK> field of the command structure thereof.

8. The method according to claim 5, wherein said first transceiver comprises an add-drop multiplexer that is operative to transmit messages over said communication channel to only said first transceiver as a valid single destination address, using said single destination address-based management communication protocol.

9. An arrangement for enabling a network management device to conduct management communications with any of a plurality of network element devices at a remote site, by way of a first transceiver at said host site that is operative to communicate over a communication channel with a second transceiver at said remote site, said second transceiver being coupled to said plurality of network element devices, said network management device being operative to assemble a management communication message, in accordance with a single destination address-based management communication protocol that supports identification and routing of management messages to only a single destination address, said protocol having a command message structure having a target identification field that specifies a single destination address, and an intentionally empty field, said arrangement comprising:
a management communication message processor coupled to receive said management communication message as assembled by said network management device and being operative, in response to said management communication message having a target identifier field that identifies the address of one of said plurality of network element devices at said remote site, to modify said management message, so as to derive a reformatted management message, in which said target address identifier field specifies said second transceiver, and said intentionally unused information field contains information that identifies said selected one of said plurality of network element devices at said remote site;
said first transceiver being operative to transmit said reformatted management message over said communication channel to said second transceiver at said remote site as identified by said target address identifier field of said reformatted message; and
said second transceiver at said remote site being operative to receive said reformatted management message, and to forward said reformatted management message to said selected one of said plurality of network element devices at said remote site, as identified in said unused information field.

10. The arrangement according to claim 9, wherein said second transceiver is operative to examine said reformatted management message for the presence of information in said intentionally unused information field and, in response to detecting information in said intentionally unused information field, to change the contents of said target address identifier field of said reformatted message in accordance with said information in said intentionally unused information field, so as to produce a further reformatted message, and forward said further reformatted message to a network element device whose address is contained in the target address identifier field of said further reformatted message.

11. The arrangement according to claim 9, wherein said management communication protocol corresponds to Transaction Language 1 (TL1) protocol, and said intentionally unused information field corresponds to a <GENERAL BLOCK> field of the command structure thereof.

12. The arrangement according to claim 9, wherein said first transceiver comprises an add-drop multiplexer that is operative to transmit messages over said communication channel to only said first transceiver as a valid single destination address, using said single destination address-based management communication protocol.
